(19) United States
(12) Patent Application Publication
(10) Pub. No.: US 2021/0084963 A1
(43) Pub. Date: Mar. 25, 2021

(54) NON-TOBACCO PLANT COMPOSITION PREPARATION METHOD, ELECTRONIC CIGARETTE FILLER PREPARATION METHOD, ELECTRONIC CIGARETTE FILLER, AND ELECTRONIC CIGARETTE CARTRIDGE USING SAME

(71) Applicant: TOA INDUSTRY CO., LTD., Tokyo (JP)

(72) Inventor: Ryuji WATANABE, Tokyo (JP)

(73) Assignee: TOA INDUSTRY CO., LTD., Tokyo (JP)

(21) Appl. No.: 16/970,820

(22) PCT Filed: Mar. 1, 2018
(86) PCT No.: PCT/JP2018/007858

§ 371 Date: Aug. 18, 2020

(30) Foreign Application Priority Data
Feb. 23, 2018 (JP) 2018-031043

(51) Int. Cl. A24B 15/167; C08L 39/06; C08J 3/205; A24C 5/01; A24B 15/38; A24B 15/32; A24D 1/20; A24F 40/20; A24B 15/40

(52) U.S. Cl. CPC A24B 15/167; C08L 39/06; C08J 3/2053; A24C 5/01; A24B 15/385; C08J 2401/28; A24D 1/20; A24F 40/20; A24B 15/40; C08J 2339/06; A24B 15/32

(57) ABSTRACT

A process for producing a non-tobacco plant composition and a process for producing an electronic cigarette filler to be used for an electronic cigarette using a non-tobacco plant are provided with which cooling sensation of menthol can be enjoyed, capable of keeping menthol flavor even after long-term storage. A process for producing a non-tobacco plant composition includes a menthol-dissolving step of preliminarily mixing menthol, a lower alcohol and a water-insoluble crosslinked polymer to obtain a menthol-dissolved product, and a mixing step of mixing a non-tobacco plant, an aerosol former and the menthol-dissolved product obtained by the menthol-dissolving step.

### TECHNICAL FIELD

The present invention relates to a process for producing a non-tobacco plant composition, a process for producing an electronic cigarette filler, an electronic cigarette filler, and an electronic cigarette cartridge using it.

### BACKCRUSHED ART

In recent years, in order to match a non-smoking tendency, an electronic cigarette product for enjoying tobacco by heating an electronic cigarette cartridge containing a tobacco component without using a flame so as to inhale a vaporized tobacco component is beginning to spread. As a process for producing a tobacco filler to be filled in the electronic cigarette cartridge, there is a process of powdering a tobacco leaf, making the powdered tobacco leaf into an aqueous slurry, forming the aqueous slurry into a sheet, adding oil or glycerin to the sheet, and drying the sheet (Patent Document 1).

In addition, there is disclosed to add flavoring such as menthol to a tobacco article to change flavor. For example, a technique has been disclosed to capsule menthol in the filter (Patent Document 2).

### PRIOR ART DOCUMENTS

### Patent Documents

Patent Document 1: JP-A-2010-520764

Patent Document 2: JP-A-2017-506891

### DISCLOSURE OF INVENTION

### Technical Problem

In production of a cigarette filler to be filled in an electronic cigarette cartridge, it is certainly possible to add menthol flavor by adding menthol to prepare cigarettes.

However, when the cigarettes thus prepared are left to stand, the menthol flavor will be lost.

Accordingly, attempts have been made to encapsulate menthol in the filter, however, such has problems in cost increase and complicated production procedure.

Under these circumstances, the object of the present invention is to provide a process for producing a non-tobacco plant composition to be used for an electronic cigarette using a non-tobacco plant, with which not only an aroma and flavor of the plant containing no tobacco component, but also cooling sensation of menthol can be enjoyed, capable of keeping the menthol flavor even after long-term storage.

The present invention further relates to a process for producing a non-tobacco plant composition capable of keeping menthol flavor even after long-term storage, easily at a low cost.

The present invention further provides an electronic cigarette filler using a non-tobacco plant having favorable long-term storage stability.

The present invention still further provides an electronic cigarette cartridge using a non-tobacco plant having favorable long-term storage stability.

### Solution to Problem

To achieve such objects, the present invention provides an electronic cigarette filler containing a non-tobacco plant, an aerosol former and menthol, wherein the menthol reduction rate d, defined as d={(d(24)−d(48)}/d(0), is at most 0.60, where d(0) is the content of menthol in the electronic cigarette filler, d(24) is the mass of the electronic cigarette filler after left at stand at 5° C. for 24 hours, and d(48) is the mass of the electronic cigarette filler after left at stand at 5° C. for 48 hours.

According to a preferred embodiment, the electronic cigarette filler has a menthol content of at least 0.1 mass % and at most 10 mass %.

According to a preferred embodiment, the electronic cigarette filler contains a water-insoluble crosslinked polymer.

According to a preferred embodiment, in the electronic cigarette filler, the content of the water-insoluble crosslinked polymer is at least 0.1 time and at most 20 times the menthol content.

According to a preferred embodiment, the electronic cigarette filler has a content of the water-insoluble crosslinked polymer of at least 2 mass % and at most 20 mass %.

According to a preferred embodiment, the water-insoluble crosslinked polymer is polyvinyl polypyrrolidone.

The present invention further provides an electronic cigarette cartridge to be used for an electronic cigarette main body which generates an aerosol by heating an aerosol-forming base material, comprising an aerosol-forming base material and a mouthpiece from one end to the other end, and wherein the aerosol-forming base material contains the electronic cigarette filler.

The present invention further provides a process for producing a non-tobacco plant composition, comprising a menthol-dissolving step of preliminarily mixing menthol, a lower alcohol and a water-insoluble crosslinked polymer to obtain a menthol-dissolved product, and a mixing step of mixing a non-tobacco plant, an aerosol former and the menthol-dissolved product obtained by the menthol-dissolving step.

According to a preferred embodiment, the amount of the water-insoluble crosslinked polymer added is at least 10 parts by mass and at most 2,000 parts by mass per 100 parts by mass of menthol.

According to a preferred embodiment, in the menthol-dissolving step, menthol is dissolved in the lower alcohol and then the water-insoluble crosslinked polymer is added and mixed.

According to a preferred embodiment, the lower alcohol is ethyl alcohol.

According to a preferred embodiment, the water-insoluble crosslinked polymer is polyvinyl polypyrrolidone.

The present invention still further provides a process for producing an electronic cigarette filler, which comprises a filler-forming step of forming the non-tobacco plant composition obtained by the production process into an electronic cigarette filler.

### Advantageous Effects of Invention

According to the process for producing a non-tobacco plant composition and the process for producing an electronic cigarette filler of the present invention, it is possible to produce a non-tobacco plant composition and an electronic cigarette filler with which cooling sensation of menthol can be enjoyed even after long term storage.

According to the electronic cigarette filler and the electric cigarette cartridge of the present invention, cooling sensation of menthol can be enjoyed even after long term storage.

### BRIEF DESCRIPTION OF DRAWINGS

FIG. 1 is a view illustrating an embodiment of use of an electronic cigarette cartridge.

FIG. 2 is a view illustrating an example of the structure of an electronic cigarette cartridge.

FIG. 3 is a view illustrating an example of a filler produced as an electronic cigarette filler.

FIG. 4 is a view illustrating a method for preparing an electronic cigarette cartridge.

FIG. 5 is views illustrating a modified example of an electronic cigarette cartridge.

FIG. 6 is a flowchart illustrating steps of a process for producing a non-tobacco plant composition and an electronic cigarette filler in an embodiment of the present invention.

FIG. 7 is a view illustrating another embodiment of use of an electronic cigarette cartridge.

FIG. 8 is a view illustrating another embodiment of the structure of an electronic cigarette cartridge.

### DESCRIPTION OF EMBODIMENTS

Now, embodiments of the present invention will be described in detail with reference to the drawings. The present invention is not limited to the following embodiments. In the description of the drawings, the same elements are expressed by the same symbols, and duplicate descriptions are omitted. Further, the dimensional ratio in the drawing may sometimes be different from the actual ratio for convenience of explanation.

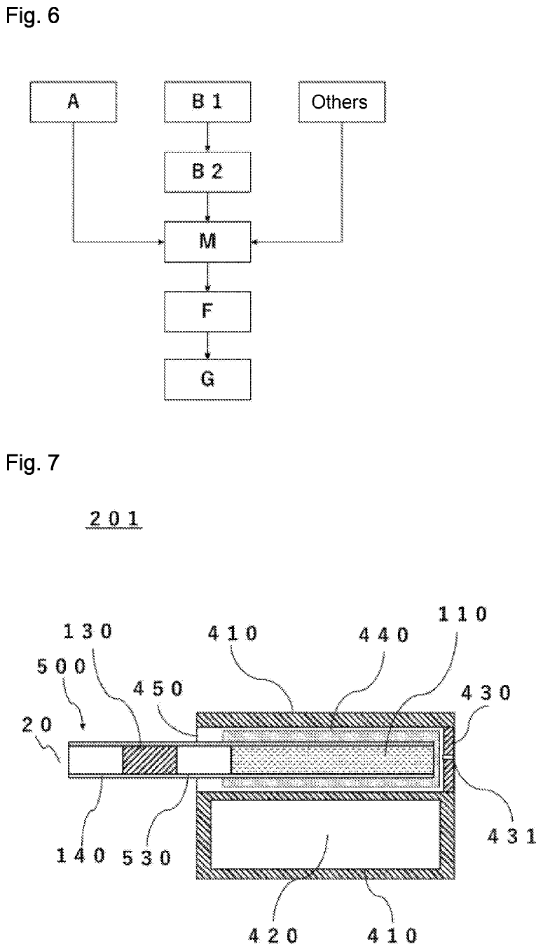

FIG. 6 is a flowchart illustrating steps of a process for producing a non-tobacco plant composition and an electronic cigarette filler in an embodiment of the present invention.

The process has a drying/crushing step (A) of drying/crushing the non-tobacco plant which will produce the aroma, and the like. In a case where the raw material can be used as it is, this step can be omitted.

Further, a step (B1) of weighing menthol, a lower alcohol and a water-insoluble crosslinked polymer is followed by a menthol-dissolving step (B2) of mixing the weighed menthol, lower alcohol and water-insoluble crosslinked polymer and dissolving menthol. A non-tobacco plant composition is obtained by means of a mixing step (M) of mixing the menthol-dissolved product with other materials such as an aerosol former to prepare the non-tobacco plant composition.

The non-tobacco plant composition is formed into a desired shape by means of a filler-forming step (F). The non-tobacco plant composition formed into a desired shape is, as the electronic cigarette filler, subjected to an electronic cigarette cartridge production step (G) and formed into an electronic cigarette cartridge.

The respective steps will be described in order. For convenience of explanation, the above steps are explained individually, but two or more steps may be conducted simultaneously. The non-tobacco plant as the raw material will be described in detail later.

First, in the drying/crushing process, in order to form a use site (for example, leaves, seeds, dried fruits, stems, barks, roots, or the like) of the non-tobacco plant as the raw material, into a non-tobacco plant composition, the use site is processed into a predetermined crushed material. In this case, it is preferred to adjust the moisture content to be convenient for absorbing or supporting the aerosol former, water, and other components to be added later.

The drying temperature is preferably at least 60° C. and at most 80° C. Within this range, it is easy to achieve a desired moisture content while avoiding dissipation of a required flavor component. When the temperature is at least 65° C., the desired moisture content can be more easily achieved, and when the temperature is at most 75° C., dissipation of a required flavor component can be further prevented.

The moisture content after drying and crushing is preferably at most 5 mass %, whereby a slurry is easily formed in a later process. The moisture content is more preferably at most 3 mass %. Further, when the moisture content is at least 0.1 mass %, it is possible to maintain a good compatibility with water or the like.

Furthermore, the drying/crushing step (A) can include a sieving step for sieving the dried and crushed product, and thus, the dried and crushed product having a desired particle size can be introduced into the mixing step (M).

After the weighing step (B1), the menthol-dissolving step (B2) of mixing menthol, a lower alcohol and a water-insoluble crosslinked polymer and dissolving menthol is conducted, and in this step, menthol, the lower alcohol and the water-insoluble crosslinked polymer are mixed and dissolved. It is preferred that menthol is dissolved in the lower alcohol and then the water-insoluble crosslinked polymer is added and mixed.

Here, menthol is not limited to natural product and may be synthetic product. Further, mentha herb, mint, peppermint oil and others including menthol may also be used. The lower alcohol is a solvent in which menthol is dissolved, and is particularly preferably ethyl alcohol.

In the present invention, the water-insoluble crosslinked polymer means a crosslinked polymer obtained by crosslinking a water soluble polymer, which is insoluble and swells in water. The water-insoluble crosslinked polymer preferably is not soluble and swells in the lower alcohol, and such a polymer is selected. Such a water-insoluble crosslinked polymer has a hydrophilic moiety and a hydrophobic moiety and produces the effects of the present invention by the hydrophilic moiety contributing to swelling and the hydrophilic moiety being oriented to menthol. As preferred examples, polyvinyl polypyrrolidone which is a crosslinked product of polyvinylpyrrolidone, and water-insoluble crosslinked polysaccharides obtained by crosslinking water-soluble polysaccharides, which are epoxy-crosslinked, ester-crosslinked or ether-crosslinked may be mentioned.

In the present invention, particularly favorable results are obtained when ethanol and polyvinyl polypyrrolidone are used together with menthol.

The amount of menthol to be added is set to achieve desired flavor. To add menthol flavor, the content of menthol in the electronic cigarette filler is at least 0.1 mass % and at most 10 mass % as a guide. It is preferably at least 0.2 mass % and at most 5 mass % as another guide.

In preparation of the non-tobacco plant composition, the amount of the water-insoluble crosslinked polymer is preferably at least 10 parts by mass and at most 2,000 parts by mass per 100 parts by mass of menthol, more preferably at least 50 parts by mass and at most 600 parts by mass. In other words, the content of the water-insoluble crosslinked polymer is at least 0.1 time and at most 20 times, preferably at least 0.5 time and at most 6 times, the content of menthol.

In order to obtain the effects of the present invention, the amount of the water-insoluble crosslinked polymer in the electronic cigarette filler is at least 2 mass %, preferably at least 4 mass % at the minimum, whereby the effect of the present invention regarding the long-term storage stability will be obtained. Further, the amount is preferably not higher than 10 mass %. When the amount is within 10 mass %, flavor derived from polyphenol and the like derived from the non-tobacco plant can be kept.

The amount of the lower alcohol to be used is preferably at least 50 parts by mass per 100 parts by mass of menthol. Further, when it is at least 100 parts by mass, the water-insoluble crosslinked polymer can be sufficiently effectively mixed while menthol is dissolved. When the amount is at most 2,000 parts by mass, remaining of the lower alcohol in the subsequent steps can be reduced, whereby the production steps will be effectively conducted.

Now, the mixing step (M) of conducting mixing will be described below.

The non-tobacco plant as the raw material is subjected to the drying/crushing step (A) if necessary, is weighed, and is subjected to the mixing step (M).

Now, the non-tobacco plant to be used as the raw material will be described. The non-tobacco plant which can be used in the present embodiment is not particularly limited as long as it is a plant other than tobacco. As a part of the plant to be used, for example, various parts such as a root (including a bulb, a tuberous root (potatoes), a corm, and the like), a stem, a tuber, a skin (including a stem bark, a bark, and the like), a leaf, a flower (including a petal, a stamen, a pistil, and the like), and a trunk and a branch of a tree can be used.

There are onion, red spider lily, tulip, hyacinth, garlic, Allium chinense, and lily as the bulb, there are crocus, gladiolus, freesia, iris, taro, and Konjac as the corm, there are cyclamen, anemone, begonia, crosne, potato, and groundnut as the tuber, there are canna, lotus root, and ginger as a rhizome, there are dahlia, sweet potato, cassava, and Jerusalem artichoke as a tuberous root, there is dioscorea (yams such as yam, Japanese yam, and Chinese yam) as a rhizophore, and others include turnip, burdock, carrot, Japanese radish, and East Asian arrowroot. As a stem, there are konjac, asparagus, bamboo shoot, udo, Japanese radish, and yacon.

The above-mentioned potatoes and plants listed below contain carbohydrates and are preferably used as a material of at least a portion of the filler 111. For example, as a starch, there are corn starch (corn), potato starch (potato), sweet potato starch (sweet potato), tapioca starch (tapioca), and the like, and there are examples of use as thickeners, stabilizers and the like. The starch can improve acid resistance, heat resistance, shear resistance and the like by crosslinking, can improve storage stability, gelatinization promotion and the like by esterification and etherification, and can improve transparency, film properties, storage stability and the like by oxidation.

It is possible to obtain tamarind seed gum, guar gum and locust bean gum from a plant seed, to obtain arabic gum and karaya gum from sap, to obtain pectin from a fruit, and to obtain cellulose, konjak mannan mainly composed of agarose, and soybean polysaccharide from other plants. Further, it can be used after being denatured like cationized guar gum.

From seaweed, carrageenan classified into three types of kappa carrageenan, iota carrageenan and lambda carrageenan, agar, and alginic acid can be obtained, and these are also used as a salt such as a carrageenan metal salt or sodium alginate.

As specific examples, as plants used as herbs and spices, gardenia nut, citrus leaf, Japanese ginger, mugwort, wasabi, ajowan seed, anise, alfalfa, echinacea, shallot, estragon, everlasting flower, elder, allspice, orris root, oregano, orange peel, orange flower, orange leaf, cayenne chili pepper, chamomile german, chamomile roman, cardamon, curry leaf, garlic, catnip, caraway, caraway seed, sweet osmanthus, cumin, cumin seed, clove, green cardamon, green pepper, coneflower, saffron, cedar, cinnamon, jasmine, juniper berries, jolokia, ginger, star anise, spearmint, sumac, sage, savory, celery, celery seed, turmeric (Curcuma longa), thyme, tamarind, tarragon, chervil, chives, dill, dill seed, tomato (dried tomato), tonka bean, dried phakchi, nutmeg, hibiscus, habanero chili, jalapeno, bird's eye chili, basil, vanilla, phakchi (coriander), parsley, paprika, hyssop, Piment d′Espelette, pink pepper, fenugreek seed, fennel, brown mustard, black cardamon, black cumin, black pepper, vetiver, pennyroyal, peppermint (mint), horseradish, white pepper, white mustard, poppy seed, porcini, marjoram, mustard seed, melegueta, marigold, malva flower, mace, yarrow flower, eucalyptus, lavender, licorice, linden, red clover, red pepper, lemon grass, lemon verbena, lemon balm, lemon peel, rose, rosebuds (purple), rose hip, rose petal, rosemary, rose red, laurel (bay leaf), long pepper, sesame (raw sesame, roasted sesame), golden chili pepper, sichuan pepper (hoajao), santaka pepper, zanthoxylum fruit, cayenne pepper, yuzu, and the like can be used. In addition, a mixture of various plants used as mixed spices (for example, five-spice powder, garam masala, ras el hanout, barigoule, chicken curry masala, tandoori masala, quatre epice, and herbes de provence), potpourri, and the like can be used.

In addition, for example, it is possible to use edible fruits (flesh portion) and seeds of e.g. peach, blueberry, lemon, orange, apple, banana, pineapple, mango, grape, kumquat, melon, plum, almond, cacao, coffee beans, peanut, sunflower, olive, walnut, and other nuts.

In addition, teas can be used. Teas differ not only in the plant which becomes tea, but even in the same plant, they become different teas depending on a processing method. Specifically, examples of tea include Japanese tea, black tea, Angelica keiskei tea, Amacha, fiveleaf ginseng tea, aloe tea, ginkgo leaf tea, oolong tea, turmeric tea, Quercus salicina tea, Acanthopanax senticosus tea, Chinese plantain tea, alehoof tea, persimmon leaf tea, chamomile tea, chamomile tea, Chamaecrista nomame tea, quince tea, chrysanthemum tea, gymnema tea, guava tea, Chinese matrimony vine tea, mulberry tea, black bean tea, Geranium thunbergii tea, brown rice tea, burdock tea, comfrey tea, sea tangle tea, cherry blossom tea, saffron tea, shiitake tea, red shiso tea, jasmine tea, ginger tea, field horsetail tea, Japanese sweet flag tea, Swertia japonica tea, buckwheat tea, Aralia elata tea, dandelion tea, tian cha, Houttuynia cordata tea, Eucommia ulmoides tea, sword bean tea, Japanese red elder tea, Ligustrum japonicum tea, adlay tea, Senna obtusifolia tea, loquat leaf tea, per tea, safflower tea, pine needle tea, mate tea, barley tea, Acer maximowiczianum tea, mugwort tea, eucalyptus tea, Momordica grosvenorii tea, rooibos tea, bitter melon tea, and the like. For these teas, tea leaves after drinking may be used. If the tea leaves are used, it is possible to effectively reuse expensive tea or the like.

As specific examples of plants which can be used, sea tangle is mentioned, and in addition, as plants, sea lettuce, green laver, Sargassum horneri, Pyropia tenera, arame, rock seaweed, Campylaephora hypnaeoides, Gracilaria vermiculophylla, Saccharina sculpera, Ecklonia cava Kjellman, Laminariaceae rhizoid, Caulerpa lentillifera, Ecklonia kurome, Kombu, Pyropia yezoensis, dulse, Pyropia kurogii, Ecklonia stolonifera, gelidium, Saccharina gyrata, Arthrothamnus ruprecht, nori, Petalonia binghamiae, hijiki, Monostroma nitidum, Undaria undarioides, Gloiopeltis, Ulva intestinalis, Saccharina japonica, mekabu, Nemacystus decipiens, wakame, and the like can also be used.

As specific examples of plants which can be used, brown rice is mentioned, and as other rice varieties, Indica rice (indian, continental and long-grain), Oryza glaberrima (African rice), Oryza sativa (Asian rice), javanica rice (Java, tropical island and large grain), japonica rice (Japanese, temperate island and short grain), and NERICA (interspecific hybrid between Asian rice and African rice) can be also used, and can be also used as powder or rice bran.

As specific examples of plants which can be used, barley is mentioned, and as other barley varieties, Foxtail millet, oats (cultivated species of common wild oat), barley, common wild oat, common millet, Paspalum scrobiculatum (Kodo millet), wheat, finger millet, teff, pearl millet, naked barley (a variety of barley), Job's tears (fruits, not seeds), Japanese barnyard millet, fonio, Manchurian wild rice, glutinous barley, sorghum (great millet, kaoliang and sorghum), corn and rye can be also used.

As specific examples of plants which can be used, black bean is mentioned, and as other legume variety, adzuki bean, carbo, kidney bean, pea, pigeon pea, cluster bean, grass pea (Lathyrus sativus), black gram, cowpea, winged bean, geocarpa groundnut, broad bean, soybean, ricebean, jack bean, tamarind, tepary bean, sword bean, velvet bean (Mucuna pruriens), bambara bean, chickpea, hyacinth bean, runner bean, horse gram (Macrotyloma uniflorum), moth bean, lima bean, peanut, mung bean, Lupinus, lentil, and almond can be also used.

As specific examples of plants which can be used, buckwheat is mentioned, and as examples of other plants, amaranth (Amaranthus and Amaranthus caudatus), quinoa and tartary buckwheat can be also used.

As specific examples of plants which can be used, shiitake is mentioned, and as mushroom varieties, pine mushroom, shiitake, Lactarius hatsutake, Shimeji, Rhizopogon roseolus, common mushroom and field mushroom can be also used.

In addition, it is possible to use sugar cane (draff of molasses may be used), sugar beet (beet), stems and branches of trees with aroma such as Japanese cypress, pine, Cryptomeria japonica, Sawara cypress, camellia and sandalwood, and barks, leaves and roots thereof. Ferns, mosses, and the like can also be used as non-tobacco plants. Further, as the plants, for example, by-products, pomace (sake lees, pomace of grape (composed of skin, seeds, fruit axis, and the like of grape)), and the like in production of fermented liquors such as sake and wine can be used.

Furthermore, various plants described above may be used as mixed. Of course, plants other than those listed here can also be used.

In addition, those known as traditional Chinese medicine are also preferably used. Examples of the above include: indigo plant, Rubia argyi, mallotus bark, gambir, benzoin, clematis root, Artemisia capillaris flower, fennel, turmeric, processed mume, lindera root, Quercus salicina, bearberry leaf, rose fruit, corydalis tuber, isodon herb, astragalus root, scutellaria root, polygonatum rhizome, phellodendron bark, coptis rhizome, cherry bark, Hypericum erectum, polygala root, Sophora japonica flower, Allium macrostemon, prunella spike, myrobalan fruit, polygonum root, curcuma rhizome, pogostemon herb, pueraria root, german chamomile, trichosanthes root, trichosanthes seed, processed ginger, glycyrrhiza, coltsfoot flower, artemisia leaf, platycodon root, Hovenia dulcis, orange fruit, immature orange, chrysanthemum flower, citrus peel, notopterygium, apricot kernel, kumquat, lonicera flower, alehoof, lycium fruit, lycium leaf, sophora root, walnut, chinaberry bark, Lindera umbellata, Dianthus chinensis, schizonepeta spike, cinnamon bark, cassia seed, pharbitis seed, scrophularia root, koi, safflower, albizziae cortex, Dalbergia odorifera, fermented black soybean, elsholtzia herb, red ginseng, Cyperus rhizoma, brown rice, magnolia bark, Ligusticum sinense rhizome, acanthopanax bark, achyranthes root, euodia fruit, Japanese knotweed, burdock fruit, Schisandra fruit, bupleurum root, asiasarum root, saffron, smilax rhizome, crataegus fruit, gardenia fruit, cornus fruit, subprostrata root, jujube seed, japanese zanthoxylum peel, sparganium rhizome, dioscorea rhizome, rehmannia root, aster root, lycii cortex, lithospermum root, perilla fruit, perilla leaves, tribulus fruit, persimmon calyx, bassia scoparia fruit, peony root, chidium monnieri fruit, adenophora root, plantago seed, plantago herb, amomum seed, houttuynia herb, ginger, palm fruit, palm leaf, cimicifuga rhizome, wheat, sweet flag root, biond magnolia flower, Ligustrum japonicum, ash bark, malted rice, Gentiana lutea root, Leonurus japonicus seed, zanthoxylum simulans seed, immature citrus unshiu peel, Acorus gramineus rhizome, granati cortex, dendrobium, cnidium rhizome peucedanum root, nuphar rhizome, inula flower, Sambucus sieboldiana leaf, Lanxangia tsaoko fruit, gleditsiae semen, colored mistletoe herb, siberian cocklebur fruit, atractylodes lancea rhizome, oriental arborvitae leafy twig, himalayan teasel root, mulberry bark, sappan wood, perilla herb, chinese honeylocust abnozmal fruit, rhubarb, jujube, areca pericarp, alisma tuber, Salvia miltiorrhiza root, bamboo culm, Panax japonicus rhizome, bamboo leaf, common anemarrhena rhizome, garden burnet root, clove, uncaria hook, citrus unshiu peel, arisaema tuber, gastrodia tuber, asparagus root, benincasa seed, japanese angelica root, castor seed, codonopsis root, rush, peach kernel, bitter orange peel, dodder seed, aesculus turbinate, eucommia bark, aralia rhizome, Trichosanthes cucumeroides, cistanche herb, nutmeg, lonicera leaf and stem, ginseng, fritillaria bulb, malt, Platycladus orientalis kernel, Lablab purpureus seed, ophiopogon root, Malaytea scurfpea fruit, mentha herb, unripe guara fruit, pinellia tuber, agkistrodon skin, isatis root, barbated skullcup herb, lily root, Angelica dahurica root, Hedyotis diffusa, stemona root, atractylodes rhizome, areca, sinomenium stem and rhizome, imperata rhizome, saposhnikovia root rhizome, Typha latifolia, dandelion root, moutan bark, ephedra herb, hemp fruit, shrub chaste tree fruit, pine resin, akebia stem, chaenomeles fruit, saussurea root, myrrh, common scouring rush herb, blackberry lily rhizome, bitter cardamom, Reynoutria multiflora, grosvenor momordica fruit, eupatorium japonicum, longan aril, Japanese gentian, Alpiniae officinarum rhizome, ganoderma, forsythia fruit, Glechoma hederacea herb, nelumbo seed, and phragmites rhizome.

In addition, extracts of the non-tobacco plants exemplified above, so-called extracts can also be used. Examples of the form of the extract include liquid, syrup, powder, granules and solution.

Among the above-exemplified non-tobacco plants, ones which are not required to be dried and crushed, may be subjected to the mixing step (M) as they are.

As the aerosol former, glycerin, propylene glycol, sorbitol, triethylene glycol, lactic acid, diacetin (glycerin diacetate), triacetin (glycerin triacetate), triethylene glycol diacetate, triethyl citrate, isopropyl myristate, methyl stearate, dimethyl dodecanedioate, dimethyl tetradecanedioate, or the like can be used, and glycerin and propylene glycol are particularly preferably used. These are used in an amount of at least 1 mass % and at most 80 mass % to the electronic cigarette filler, particularly preferably at least 10 mass % and at most 40 mass %.

In addition, if necessary, a flavor additive which adds flavor is also preferably used. The flavor additive may, for example, be an extract of mint, cocoa, coffee, black tea, or the like.

In addition, if necessary, a preservative for food may be added, and for example, sorbic acid, potassium sorbate, benzoic acid, sodium benzoate or the like may be added.

As materials other than the above, as binders, thickeners, and the like, gums such as guar gum, xanthan gum, gum arabic, or locust bean gum, for example, cellulose binders such as hydroxypropyl cellulose, carboxymethyl cellulose, hydroxyethyl cellulose, methyl cellulose and ethyl cellulose, polysaccharides such as starch, organic acids such as alginic acid, sodium alginate, sodium carboxymethyl cellulose, carrageenan, conjugate bases of organic acids such as agar and pectin, and combinations thereof are also used.

The above exemplified aerosol former, flavor additive, preservative, binder, thickener, etc. are prepared in a step others in FIG. 6 and subjected to the mixing step (M).

In the mixing step (M), a normal mixer can be used. For example, it is preferred to mix the material in a mixing tank while applying a shear force by a stirring blade.

The dried and crushed product of the non-tobacco plant, the aerosol former, the menthol dissolved product obtained in the menthol-dissolving step (B2), a binder or a thicker, and water if necessary, are mixed, whereby a non-tobacco plant composition is obtained.

Then, the filler-forming step (F) may be conducted, for example, by a method of pressurizing the non-tobacco plant composition to make it pass through an orifice thereby to form rods, a method of forming the composition into a thin sheet, or a method of e.g. drying and crushing the non-tobacco composition thereby to form particles.

In the present invention, a method of forming the composition into a thin sheet, followed by cutting, will be described in detail. A three-roll mill is prepared to form a thin sheet. It is preferred to use the three-roll mill, whereby it is possible to obtain a sheet having a desired thickness by a doctor blade while performing kneading, dispersion, or the like by compression by pushing the composition between narrow rolls and by shearing due to a roll speed difference. Further, it is also preferred to prepare a sheet using a press roller or a pressing machine.

Further, in the filler-forming step (F), if necessary, the non-tobacco plant, the aerosol former, the binder, the thickener or the like, the flavor additive, the preservative may be further added, or water may be added.

In the present invention, as water to be used for production, it is preferred to use water which is sterilized or water from which microorganisms are removed, and it is preferable to use pure water obtained by a reverse osmosis membrane, ion exchange, or the like.

The thickness of the sheet obtained in the filler-forming step (F) is preferably at least 0.1 mm to 1.0 mm, more preferably at least 0.1 mm to 0.5 mm. The obtained sheet is cut by a cutter into a desired shape, and for cutting, a cutter, a rotary blade type rotary cutter may, for example, be mentioned.

As a specific example of the filler-forming step (F), cutting a sheet having a thickness of 0.3 mm into a desired shape will be described as an example. For example, the sheet is cut into a rectangle of 150 mm×240 mm. The sheet is cut by a rotary cutter into a shape of 1.5 mm×240 mm to obtain a cut sheet product. 50 such cut sheet products are wrapped with tobacco paper to prepare a roll having an outer diameter of approximately 6.9 mm. The roll is cut by a cutter into a length of 12.0 mm to obtain an aerosol-forming base material (110). On that occasion, the mass of the filler is 0.29 g. The proportion of the volume of the filler to the volume of the aerosol-forming base material (110), which is called the volume filling rate, is 0.60 in the above case. That is, the density of the filler calculated from the volume filling rate and the mass of the filler is 1.07 g/cm³.

In the above filler-forming step (F), a plurality of rods or rectangular strips constituting the filler are arranged along the longitudinal direction of the electronic cigarette cartridge. Further, the plurality of rods or rectangular strips constituting the filler are wrapped with a wrapping member (151) such as tobacco paper along the axis of the height of the roll to form an aerosol-forming base material (110).

The electronic cigarette cartridge production step (G) will be described. The aerosol-forming base material (110) thus obtained and a support element (300), which will be described in detail later, and a mouthpiece (140) are wrapped with a packaging member (150), or a packaging member (150) is preliminarily formed into a cylinder, to which a mouthpiece (140), a support element (300) and a filler (110) are inserted, to prepare an electronic cigarette cartridge.

As an example of a preferred constitution of the present invention, an electronic cigarette cartridge comprising the aerosol-forming base material (110), the support element (300) and the mouthpiece (140) disposed from the upstream side (10) toward downstream (20) may be mentioned.

In a case where the heating element of the electronic cigarette main body of the present invention is inserted, in a preferred embodiment, the effect of suppressing sublimation of menthol can be sufficiently obtained. As such an embodiment, a filler formed into a shape having a length of at least 10 mm and at most 20 mm, a width of at least 1.1 mm and at most 2.0 mm and a thickness of at least 0.1 mm and at most 0.5 mm may be mentioned as an example. Such a shape, with a relatively large surface area, is likely to give menthol flavor at the time of cigarette use, and also tends to lead to sublimation.

By the electronic cigarette filler containing menthol and the water-insoluble crosslinked polymer, preferably polyvinyl polypyrrolidone, sublimation of menthol can be effectively suppressed even in the above shape. By adding menthol preliminarily dissolved in the lower alcohol preferably ethanol in the production process, more favorable effects can be obtained.

Properties of the electronic cigarette filler thus prepared may be confirmed by observing a state where menthol contained in the non-tobacco plant composition or the electronic cigarette filler is lost.

In the present invention, from about 5 g to about 10 g of the prepared non-tobacco plant composition or electronic cigarette filler is accurately weighed at 17° C. under a relative humidity of 65%, sealed in a polyethylene bag and stirred in a 5° C. environment for 24 hours or for 48 hours. The surface of the non-tobacco plant composition or electronic cigarette filler is observed after stored for 24 hours or for 48 hours, and precipitation of white crystals is observed. The white crystals being observed means that menthol is crystalized while it sublimes from the non-tobacco plant composition or the electronic cigarette filler. Further, the plastic bag is stored in a sealed state as it is at 17° C. under a relative humidity of 65% for 3 hours and opened, and immediately, the non-tobacco plant composition or the electronic cigarette filler is accurately weighed to obtain the change of the mass. By such a method, it is possible to quantitatively measure the loss of menthol.

The storage test is conducted in a 5° C. environment because dissipation of other components in the non-tobacco plant composition or the electronic cigarette filler can be suppressed under such a condition, and the condition is appropriate to evaluate the state of dissipation of menthol. Particularly, to prevent dissipation of white crystals is effective to prevent discomfortableness by the user with the precipitated menthol on the electronic cigarette cartridge packaged and transported/stored in the market.

In the present invention, the menthol reduction rate d is defined as d={(d(24)−d(48)}/d(0), where d(0) is the content of methanol in from about 5 g to about 10 g of the non-tobacco plant composition or the electronic cigarette filler accurately weighed at 17° C. under a relative humidity of 65%, d(24) is the mass of the non-tobacco plant composition or the electronic cigarette filler after left to stand at 5° C. for 24 hours, and d(48) is the mass of the non-tobacco plant composition or the electronic cigarette filler after left to stand at 5° C. for 48 hours.

The reason why d(48) is subtracted from d(24) is that considering components to be dissipated other than methanol, the components dissipated from 24 hours to 48 hours well reflect the precipitation of the white crystals.

In the present invention, when d is at most 0.60, precipitation of the white crystals can be suppressed. It is preferably at most 0.50, more preferably at most 0.30, further preferably at most 0.20.

Now, an example of use of the produced electronic cigarette filler will be described.

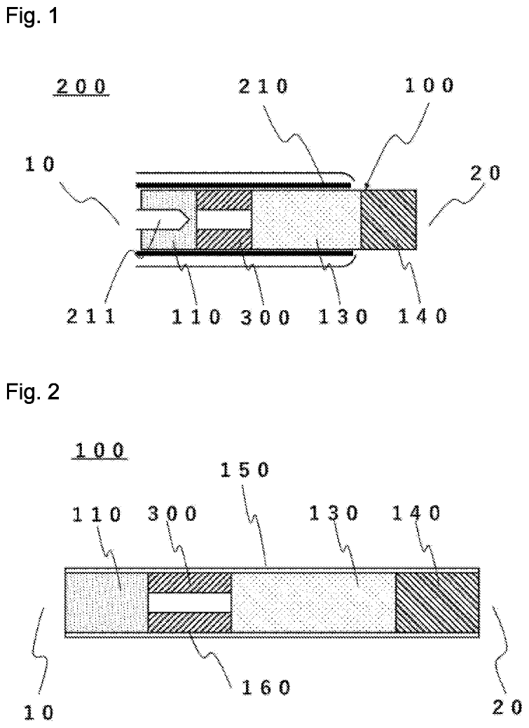

FIG. 1 illustrates an embodiment of use of an electronic cigarette cartridge. An electronic cigarette cartridge (100) is mounted on an electronic cigarette main body (200) at the time of use by the user. The electronic cigarette main body (200) is provided with an inserting portion (210) for inserting the electronic cigarette cartridge (100).

A heating element (211) is provided at a center portion of a bottom inside the inserting portion (210), and the heating element (211) has a member in the form of a blade or in the form of a pin having a sharp front end, and is inserted into the aerosol-forming base material (110) and heats the aerosol-forming base material (110). More specifically, the heating element (211), when the electronic cigarette cartridge (100) is inserted into the inserting portion (210) of the electronic cigarette main body (200), is inserted into the center portion of the aerosol-forming base material (110).

The heating element (211) generates heat directly or indirectly by an electric power supplied from a battery (not shown in the diagram) provided inside the electronic cigarette main body (200). By the aerosol-forming base material (110) being heated by the heat of this heating element (211), an aerosol containing an aroma component is generated. Moreover, the aerosol generated is transferred to a mouthpiece (140) via a support element (300) and an aerosol transferring member (130) which will be described later, and inhaled by the user from the mouthpiece (140) side, whereby the aroma component is delivered into a mouth of the user. Hereinafter, for description of the present invention, the aerosol-forming base material (110) side of the electronic cigarette cartridge will be referred to as upstream side (10), and the mouthpiece side will be referred to as downstream side (20). Further, the upstream side (10) will sometimes be referred to as one end side, and the downstream side (20) will sometimes be referred to as the other end side.

FIG. 1 illustrates a case where the heating element (211) has one member in the form of a pin or a blade, and as an example of another embodiment, the heating element (211) has a plurality of members in the form of a pin or a blade.

FIG. 2 illustrates an example of a structure of an electronic cigarette cartridge (100). From the side where the heating element (211) is inserted, that is, from the upstream side (10) toward the downstream side (20), an aerosol-forming base material (110), a support element (300), a transferring member (130) and a mouthpiece (140) are disposed in this order.

The support element (300) supports the aerosol-forming base material (110). The support element (300) is disposed adjacent to the aerosol-forming base material (110), and a side portion (160) of the support element (300) is in contact with a packaging member (150) located on a periphery of the electronic cigarette cartridge (100). The side portion (160) is fixed to the inside of the packaging member (150) for example by an adhesive.

Further, the support element (300) may suitably be formed by using, for example, silicone, but the support element is not limited to silicone, and other material excellent in heat resistance may be used.

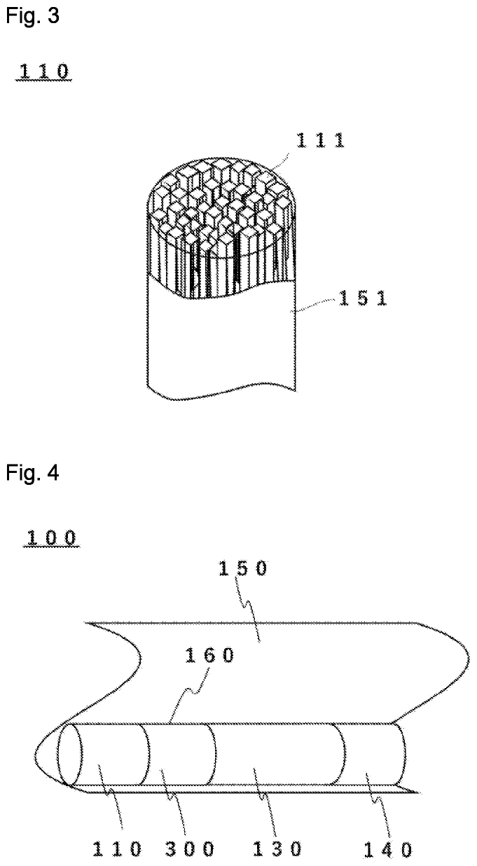

As shown in FIG. 3, the filler (111) produced as the aerosol-forming base material (110) is preferably in the form of rods or rectangular strips, which are filled in so as to be along the longitudinal direction of the shape of the filler (111). In this example, the filler is filled in a wrapping member (151) formed into a cylinder. As the wrapping member (151), one having paper such as tobacco paper formed into a cylinder may be used. Further, the packaging member (150) may function also as the wrapping member (151). In such a structure, an air flow is stabilized, and it becomes easy for the user to inhale an aroma component from the aerosol-forming base material (110).

In FIG. 4, the above formed aerosol-forming base material (110), a transferring member (130), a mouthpiece (140) and the following support element (300) are disposed adjacent to one another in the order of the aerosol-forming base material (110), the support element (300), the transferring member (130) and the mouthpiece (140), and wrapped with a packaging member (150) such as tobacco paper to form a rod. In such a case, to a side portion (160) of the support element, an adhesive in a small amount is applied. An electronic cigarette cartridge (100) is constituted as above.

Now, an example of use of the electronic cigarette cartridge of the present invention will be described in detail.

An electronic cigarette cartridge (100) has an outer appearance of, for example, a rod or a cylinder, as shown in FIG. 2.

In the interior of the electronic cigarette cartridge (100), for example, as shown in FIG. 2, an aerosol-forming base material (110) is provided at one end, and toward a mouthpiece (140) on the other end, a support element (300) and a transferring member (130) are disposed in this order. And, these components are wrapped with a wrapping member (150).

The aerosol-forming base material (110) has an electronic cigarette filler. The aerosol-forming base material (110) generates an aerosol containing an aroma component contained in the plant from which the filler originates, by heating.

When the filler as the aerosol-forming base material (110) is, as shown in FIG. 3, in the form of pieces, rectangular strips or rods such that the length of the long side is from about 2 to about 20 times the short side, the filler (111) is filled in so that its longitudinal direction is along the longitudinal direction of the cartridge, whereby fluidity of the air flow will be good, and the user can easily inhale the air flow. FIG. 3 is a diagram as viewed from the end of the side of the aerosol-forming base material (110) of the electronic cigarette cartridge, and is partially perspective so that the filler (111) in the interior of the cartridge is visible. The longest portion of each piece, strip or rod is preferably from about 1 to about 20 mm. If the longest portion is too long, handling efficiency may be impaired at the time of filling in the cartridge due to a too large size. Further, in addition to the above, for example a filler in the form of flat plates having a substantially constant shape, is easily handled since it can be filled as wound.

As other aerosol-forming base material, wrinkled, pleated, gathered or folded sheets may also be preferred.

A filler in the form of fibers is, in the same manner as the rods, facilitates flow of air when inhaled, by filling the filler so that the fiber length direction is along the longitudinal direction of the cartridge.

A filler in the form of a porous material is one of preferred embodiments, since when filled in the cartridge, it facilitates flow of air when inhaled. In order to obtain a porous material, for example, a dried sheet may be pierced by a plurality of needles, or the porous material may be obtained by other method.

The filler in the form of pieces, plates such as squares, rectangles or rhomboids, or powder, granules or pellets, can easily be filled so as to be poured into the cartridge opening. Further, the amount filled in the cartridge (filling amount) can minutely be controlled, and the flow of air when inhaled can easily be adjusted by the amount filled. Such a filler can more preferably be used by taking countermeasures such as providing a cover on the cartridge opening.

The filler in the form of blocks has a good thermal conductivity and easily draws an aroma component, and is one of preferred embodiments. Further, the size of the blocks may be increased for storage efficiency. In such a case, at the time of filling, the blocks may be formed again into smaller blocks, rods or particles.

The support element (300) supports the aerosol-forming base material (110). The support element (300) is disposed adjacent to the aerosol-forming base material (110), has an air hole or a notch for air flow at the center portion or the side portion, and makes an aerosol generated from the aerosol-forming base material (110) flow towards the mouthpiece (140) direction.

The mouthpiece (140) is adjacent to the transferring member (130) and is disposed at the other end portion of the electronic cigarette cartridge (100). The mouthpiece (140) may have a cellulose acetate filter for example, as a filter eliminating fine particles. The aroma component which has passed through the filter of the mouthpiece (140) is inhaled by the user.

As to whether the transferring member (130) is present or not, air permeability is good and an aromatic component generated is easily inhaled when there is no transferring member (130). On the other hand, it is also preferred to add a function to cool the generated aerosol by the transferring member (130). Instead of addition of the transferring member (130), it is preferred to extend the mouthpiece so as to be adjacent to or in contact with the support element (300), whereby a cooling function may be imparted to the filter to be used for the mouthpiece and the number of members can be reduced. As the transferring member (130), a hollow tubular member wrapped with a crimped polymer sheet in the electronic cigarette cartridge longitudinal direction may, for example, be used.

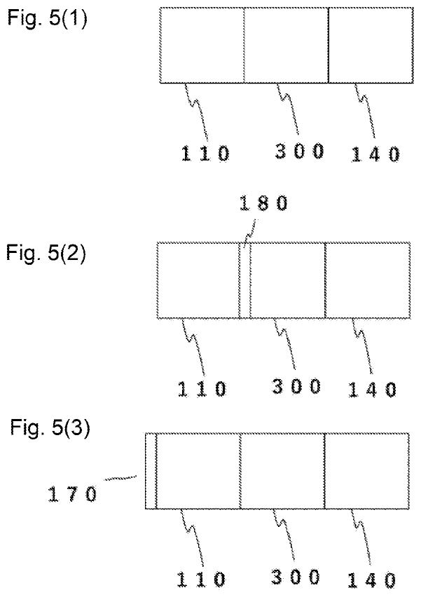

FIG. 5(1) illustrates a structure in which the aerosol-forming base material (110) and the support element (300) are in contact with each other, which is a preferred embodiment, since the aerosol-forming base material can stably be supported. Further, such a structure is advantageous in production due to a simple structure.

FIG. 5(2) illustrates a structure in which a partitioning member (180) is provided between the aerosol-forming base material (110) and the support element (300) so that they are in contact with each other via the partitioning member (180). The partitioning member (180) may be one formed of a filter, paper or the like with good air permeability, and is preferably one which will be broken when the heating element (211) is inserted. By providing such a partitioning member, it is effective to prevent the aerosol-forming base material (110) from moving in the electronic cigarette cartridge by the influence of distribution e.g. at the time of transportation.

The structure shown in FIG. 5(3) such that a cover (170) is provided on the side where the heating element (211) is inserted of the aerosol-forming base material (110) is also preferred. Such a structure is effective to prevent dissipation of aroma of the aerosol-forming base material (110). Further, such is also effective to prevent dropping of the aerosol-forming base material (110) from the electronic cigarette cartridge to the outside by the influence of distribution e.g. at the time of transportation. As a material of the cover (170), a filter, paper or sponge may, for example, be mentioned. In a case where the heating element is inserted, making one or more slits in the cover (170) or providing a circular or polygonal induction hole at the position to which the heating element is to be inserted is also a preferred embodiment.

Particularly in a case where the aerosol-forming base material (110) is in the form of particles such as a powder, granules, flakes or pellets, it is preferred to provide the partitioning member (180) or the cover (170). It is more preferred to provide both of them.

Now, a production process in the case of using black tea or the like will be described in detail, however, the present invention is not limited to the black tea or the like, and needless to say, it is applicable to the tobacco plants and the non-tobacco plants described in this specification.

One of preferred specific embodiments as the electronic cigarette cartridge is as follows. The aerosol-forming base material (110) is in a substantially cylindrical shape having the filler wrapped with e.g. tobacco paper, the diameter of the bottom or the upper surface of the substantial cylinder is at least 6.5 mm and at most 7.5 mm, and the height of the substantial cylinder is at least 11.0 mm and at most 13.0 mm. Further, it is preferred that the filler is in the form of rods or rectangular strips, which are filled along the longitudinal direction of the electronic cigarette cartridge, and the length of the filler is substantially equal to the height of the substantial cylinder, that is, at least 11.0 mm and at most 13.0 mm.

Further, the support element (300) has an outer diameter of preferably substantially equal to the diameter of the bottom or the upper surface of the substantial cylinder of the aerosol-forming base material (110). Further, it has a length of at least 9.0 mm and at most 11.0 mm.

Further, the mouthpiece (140) has a length of longer than 20.0 mm, preferably at least 21.0 mm and preferably at most 25.0 mm.

Further, the volume filling rate of the aerosol-forming base material is preferably at least 0.55 and at most 0.65.

FIG. 7 illustrates another embodiment of use of the electronic cigarette cartridge. The electronic cigarette cartridge is different in the specific structure from the above electronic cigarette cartridge (100) and thus is described below as an electronic cigarette cartridge (101). The electronic cigarette main body used is also different from the above electronic cigarette main body (200) and thus is described below as an electronic cigarette main body (201).

The electronic cigarette cartridge (101) is mounted on the electronic cigarette main body (201) at the time of use by the user. The electronic cigarette main body (201) is provided with an inserting portion (450) for inserting the electronic cigarette cartridge (101). The electronic cigarette main body (101) has an exterior portion (410), and by a heating portion (440) surrounding the periphery of the electronic cigarette cartridge, the aerosol-forming base material (110) of the electronic cigarette cartridge is heated, and an aerosol is generated and is inhaled. At the time of inhale from the other end side (20), air flows in from an air hole (0), and the generated aerosol passes through a hollow tubular member (530), a transferring member (130) and a mouthpiece (140) and is inhaled. In a control portion (420), a battery, an apparatus for controlling the heating portion, etc. are built in. A movable cover (430) is opened to clean the inside of the electronic cigarette main body after use.

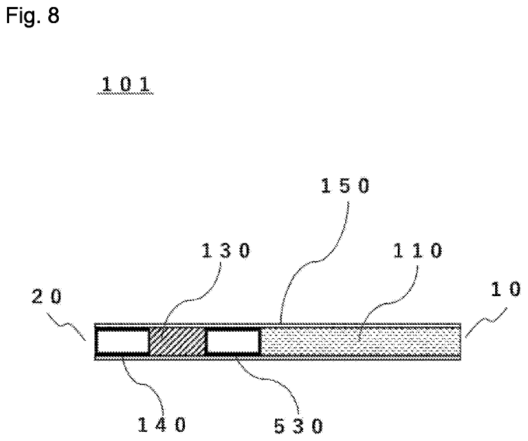

FIG. 8 illustrates another example of the structure of the electronic cigarette cartridge. From one end side (10) toward the other end side (20), an aerosol-forming base material (110), a hollow tubular member (530), a transferring member (130) and a mouthpiece (140) are disposed and are wrapped with a packaging member (150). Since the aerosol-forming base material (110) portion is heated by the electronic cigarette main body, the hollow tubular member (530) is disposed for heat insulation. The transferring member (130) may function also as a cooling member.

As a preferred shape of the electronic cigarette cartridge shown in FIG. 8, the outer diameter is at least 4 mm and at most 6 mm, and in the longitudinal direction, the aerosol-forming base material (110) is at least 30 mm and at most 70 mm, and the hollow tubular member (530) is at least 20 mm and at most 30 mm. The transferring member (130) is at least 5 mm and at most 15 mm, and the mouthpiece (140) is at least 10 mm and at most 25 mm.

Now, the present invention will be described in further detail with reference to Production Examples and Examples of the present invention.

### Production Example 1

Menthol: 100 parts by mass

Ethyl alcohol: 200 parts by mass

Polyvinyl polypyrrolidone: 200 parts by mass

The above components were weighed, and menthol was dissolved in ethyl alcohol to obtain a menthol/ethyl alcohol solution. To the menthol/ethyl alcohol solution, polyvinyl polypyrrolidone was added, followed by stirring and mixing to obtain a menthol/ethyl alcohol/polyvinyl polypyrrolidone mixture.

Xylitol: 100 parts by mass

Water: 400 parts by mass

The above components were stirred and mixed to obtain a xylitol aqueous solution.

Then, black tea leaves dried at 70° C., crushed and passed through a 80 mesh sieve were used. The moisture content was 2 mass %.

Dried and crushed black tea leaves: 100 parts by mass

Menthol/ethyl alcohol/polyvinyl polypyrrolidone mixture: 25 parts by mass

Methyl cellulose: 15 parts by mass

Glycerin: 30 parts by mass

Propylene glycol: 30 parts by mass

Sodium carboxymethylcellulose: 4 parts by mass

Xylitol aqueous solution: 8 parts by mass

Glucomannan: 1 part by mass

The above components were charged into a mixing machine and mixed for 15 minutes to obtain a non-tobacco plant composition.

The obtained non-tobacco plant composition was subjected to the filler-forming step (F). The non-tobacco plant composition was kneaded and dispersed by a three-roll mill and formed into a sheet having a desired thickness. In this Example, the non-tobacco plant composition was charged into the three-roll mill, and procedure of adding 20 parts by mass of pure water while the state of the sheet was observed, and pressing a doctor blade to a roll to obtain a sheet-shaped product, was repeated eight times.

The non-tobacco plant composition sheet thus obtained had a thickness of 0.3 mm. The non-tobacco composition sheet was cut into a rectangle of 150 mm×240 mm, and cut by a rotary cutter into a shape of 1.5 mm in width, 240 mm in length and 0.3 mm in thickness to obtain a filler. 50 such cut sheet products were bundled and aligned in a longitudinal direction, wrapped with paper having a basis weight of 34 g/m², stuck with a paste and formed into a cylinder. The inner diameter of the cylinder was 6.9 mm. The cylinder was cut into a length of 12.0 mm to form an aerosol-forming base material (110). The mass of the aerosol-forming base material was 0.29 g, and the volume filling rate of the filler to the volume of the aerosol-forming base material was 0.60.

The menthol content d(0), the mass d(24) after left to stand at 5° C. for 24 hours, the mass d(48) after left to stand at 5° C. for 48 hours, and the menthol reduction rate d of the filler are shown in Table 1.

### Production Example 2

In the same manner as in Production Example 1, a non-tobacco plant composition was obtained. In the subsequent filler-forming step (F), a non-tobacco plant composition sheet having a thickness of 0.1 mm was obtained. The non-tobacco plant composition sheet was cut into a rectangle of 150 mm×240 mm, and cut by a rotary cutter into a shape of 1.0 mm in width, 240 mm in length and 0.1 mm in thickness to obtain a filler. 225 such cut sheet products were bundled and aligned in a longitudinal direction, wrapped with paper having a basis weight of 34 g/m², stuck with a paste and formed into a cylinder. The inner diameter of the cylinder was 6.9 mm. The cylinder was cut into a length of 12.0 mm to form an aerosol-forming base material (110). The mass of the aerosol-forming base material was 0.29 g, and the volume filling rate of the filler to the volume of the aerosol-forming base material was 0.60.

The menthol content d(0), the mass d(24) after left to stand at 5° C. for 24 hours, the mass d(48) after left to stand at 5° C. for 48 hours, and the menthol reduction rate d of the filler are shown in Table 1.

### Production Example 3

In the same manner as in Production Example 1, a non-tobacco plant composition was obtained. In the subsequent filler-forming step (F), a non-tobacco plant composition sheet having a thickness of 0.5 mm was obtained. The non-tobacco plant composition sheet was cut into a rectangle of 150 mm×240 mm, and cut by a rotary cutter into a shape of 2.0 mm in width, 240 mm in length and 0.1 mm in thickness to obtain a filler. 23 such cut sheet products were bundled and aligned in a longitudinal direction, wrapped with paper having a basis weight of 34 g/m², stuck with a paste and formed into a cylinder. The inner diameter of the cylinder was 6.9 mm. The cylinder was cut into a length of 12.0 mm to form an aerosol-forming base material (110). The mass of the aerosol-forming base material was 0.29 g, and the volume filling rate of the filler to the volume of the aerosol-forming base material was 0.60.

The menthol content d(0), the mass d(24) after left to stand at 5° C. for 24 hours, the mass d(48) after left to stand at 5° C. for 48 hours, and the menthol reduction rate d of the filler are shown in Table 1.

### Production Example 4

A non-tobacco plant composition was prepared in the same manner as in Production Example 2 except that polyvinylpyrrolidone was used instead of polyvinyl polypyrrolidone. The polyvinylpyrrolidone is a water soluble polymer.

In the subsequent filler-forming step (F), a non-tobacco plant composition sheet having a thickness of 0.1 mm was obtained. The non-tobacco plant composition sheet was cut into a rectangle of 150 mm×240 mm, and cut by a rotary cutter into a shape of 1.0 mm in width, 240 mm in length and 0.1 mm in thickness to obtain a filler. 225 such cut sheet products were bundled and aligned in a longitudinal direction, wrapped with paper having a basis weight of 34 g/m², stuck with a paste and formed into a cylinder. The inner diameter of the cylinder was 6.9 mm. The cylinder was cut into a length of 12.0 mm to form an aerosol-forming base material (110). The mass of the aerosol-forming base material was 0.29 g, and the volume filling rate of the filler to the volume of the aerosol-forming base material was 0.60.

The menthol content d(0), the mass d(24) after left to stand at 5° C. for 24 hours, the mass d(48) after left to stand at 5° C. for 48 hours, and the menthol reduction rate d of the filler are shown in Table 1.

### Production Example 5

A non-tobacco plant composition was prepared in the same manner as in Production Example 1 except that polyvinyl polypyrrolidone was mixed with ethanol and then menthol was dissolved.

The subsequent filler-forming step was conducted in the same manner as in Production Example 1. In the subsequent filler-forming step (F), a non-tobacco plant composition sheet having a thickness of 0.1 mm was obtained. The non-tobacco plant composition sheet was cut into a rectangle of 150 mm×240 mm, and cut by a rotary cutter into a shape of 1.0 mm in width, 240 mm in length and 0.1 mm in thickness to obtain a filler. 50 such cut sheet products were bundled and aligned in a longitudinal direction, wrapped with paper having a basis weight of 34 g/m², stuck with a paste and formed into a cylinder. The inner diameter of the cylinder was 6.9 mm. The cylinder was cut into a length of 12.0 mm to form an aerosol-forming base material (110). The mass of the aerosol-forming base material was 0.29 g, and the volume filling rate of the filler to the volume of the aerosol-forming base material was 0.60.

The menthol content d(0), the mass d(24) after left to stand at 5° C. for 24 hours, the mass d(48) after left to stand at 5° C. for 48 hours, and the menthol reduction rate d of the filler are shown in Table 1.

### Production Example 6

Menthol: 100 parts by mass

Ethyl alcohol: 400 parts by mass

The above components were weighed, and menthol was dissolved in ethyl alcohol.

Xylitol: 100 parts by mass

Water: 100 parts by mass

The above components were stirred and mixed to obtain a xylitol aqueous solution.

Dried and crushed black tea leaves: 100 parts by mass

Menthol/ethyl alcohol solution: 25 parts by mass

Polyvinyl polypyrrolidone: 20 parts by mass

Methyl cellulose: 15 parts by mass

Glycerin: 30 parts by mass

Propylene glycol: 30 parts by mass

Sodium carboxymethylcellulose: 4 parts by mass

Xylitol aqueous solution: 8 parts by mass

Glucomannan: 1 part by mass

The above components were charged into a mixing machine and mixed for 15 minutes to obtain a non-tobacco plant composition.

The obtained non-tobacco plant composition was subjected to the filler-forming step (F). The non-tobacco plant composition was kneaded and dispersed by a three-roll mill and formed into a sheet having a desired thickness. In this Example, the non-tobacco plant composition was charged into the three-roll mill, and procedure of adding 20 parts by mass of pure water while the state of the sheet was observed, and pressing a doctor blade to a roll to obtain a sheet-shaped product, was repeated eight times.

The non-tobacco plant composition sheet thus obtained had a thickness of 0.3 mm. The non-tobacco composition sheet was cut into a rectangle of 150 mm×240 mm, and cut by a rotary cutter into a shape of 1.5 mm in width, 240 mm in length and 0.3 mm in thickness to obtain a filler. 50 such cut sheet products were bundled and aligned in a longitudinal direction, wrapped with paper having a basis weight of 34 g/m², stuck with a paste and formed into a cylinder. The inner diameter of the cylinder was 6.9 mm. The cylinder was cut into a length of 12.0 mm to form an aerosol-forming base material (110). The mass of the aerosol-forming base material was 0.29 g, and the volume filling rate of the filler to the volume of the aerosol-forming base material was 0.60.

The menthol content d(0), the mass d(24) after left to stand at 5° C. for 24 hours, the mass d(48) after left to stand at 5° C. for 48 hours, and the menthol reduction rate d of the filler are shown in Table 1.

### Production Example 7

A non-tobacco plant composition was prepared in the same manner as in Production Example 6 except that polyvinyl polypyrrolidone was not used.

The subsequent filler-forming step was conducted in the same manner as in Production Example 1. In the subsequent filler-forming step (F), a non-tobacco plant composition sheet having a thickness of 0.1 mm was obtained. The non-tobacco plant composition sheet was cut into a rectangle of 150 mm×240 mm, and cut by a rotary cutter into a shape of 1.0 mm in width, 240 mm in length and 0.1 mm in thickness to obtain a filler. 50 such cut sheet products were bundled and aligned in a longitudinal direction, wrapped with paper having a basis weight of 34 g/m², stuck with a paste and formed into a cylinder. The inner diameter of the cylinder was 6.9 mm. The cylinder was cut into a length of 12.0 mm to form an aerosol-forming base material (110). The mass of the aerosol-forming base material was 0.29 g, and the volume filling rate of the filler to the volume of the aerosol-forming base material was 0.60.

The menthol content d(0), the mass d(24) after left to stand at 5° C. for 24 hours, the mass d(48) after left to stand at 5° C. for 48 hours, and the menthol reduction rate d of the filler are shown in Table 1.

### Production Example 8

The same operation as in Production Example 1 was conducted except that 10 parts by mass of the menthol/ethyl alcohol/polyvinyl polypyrrolidone mixture was used. The menthol content d(0), the mass d(24) after left to stand at 5° C. for 24 hours, the mass d(48) after left to stand at 5° C. for 48 hours, and the menthol reduction rate d of the filler are shown in Table 1.

### Production Example 9

The same operation as in Production Example 1 was conducted except that 50 parts by mass of the menthol/ethyl alcohol/polyvinyl polypyrrolidone mixture was used.

The menthol content d(0), the mass d(24) after left to stand at 5° C. for 24 hours, the mass d(48) after left to stand at 5° C. for 48 hours, and the menthol reduction rate d of the filler are shown in Table 1.

TABLE 1

| | Sample | | | | |
|---|---|---|---|---|---|
| | amount/g | d | d(0)/g | d(24)/g | d(48)/g |
| Production | 7.796 | 0.146 | 0.198 | 7.783 | 7.754 |
| Ex. 1 | | | | | |
| Production | 7.595 | 0.161 | 0.193 | 7.580 | 7.549 |
| Ex. 2 | | | | | |
| Production | 7.934 | 0.134 | 0.202 | 7.922 | 7.895 |
| Ex. 3 | | | | | |
| Production | 7.861 | 0.621 | 0.200 | 7.817 | 7.693 |
| Ex. 4 | | | | | |
| Production | 7.660 | 0.231 | 0.195 | 7.639 | 7.594 |
| Ex. 5 | | | | | |
| Production | 7.512 | 0.440 | 0.191 | 7.481 | 7.397 |
| Ex. 6 | | | | | |
| Production | 7.192 | 0.711 | 0.193 | 7.139 | 7.002 |
| Ex. 7 | | | | | |
| Production | 7.620 | 0.172 | 0.082 | 7.609 | 7.595 |
| Ex. 8 | | | | | |
| Production | 7.740 | 0.183 | 0.512 | 7.714 | 7.620 |
| Ex. 9 | | | | | |

### Example 1

The aerosol-forming base material prepared in Production Example 1, a support element (300) which is a tubular hollow tube, and a filter (140) to be a mouthpiece were prepared. The support element (300) had a diameter of the bottom and the upper surface, that is, an outer diameter of 6.9 mm, and had a 4 mm through hole as the hollow portion. The filter (140) to be a mouthpiece had a length of 23 mm. As a packaging member, two and a half layers of paper having a basis weight of 38 g/m² were wrapped so that the inner diameter would be 6.9 mm and stuck with a paste. A paper tube prepared by wrapping two and a half layers of paper having a basis weight of at least 32 g/m² and at most 45 g/m² thus prepared, that is, a packaging member, is suitable for an electronic cigarette cartridge to be used for an electronic cigarette main body used by inserting a heating element.

An adhesive was applied to the inside of the paper tube, the filter was inserted from the other end side (20) to form a mouthpiece (140), and from one end side (10), the support element (300) was inserted and then the aerosol-forming base material was inserted. Further, at a portion of the mouthpiece, paper having a basis weight of 40 g/m² was wound so as to substantially cover the mouthpiece (140).

In such a manner, an electronic cigarette cartridge was prepared.

### Example 2

An electronic cigarette cartridge was prepared in the same manner as in Example 1 except that the aerosol-forming base material prepared in Production Example 2 was used instead of the aerosol-forming base material in Production Example 1.

### Example 3

An electronic cigarette cartridge was prepared in the same manner as in Example 1 except that the aerosol-forming base material prepared in Production Example 3 was used instead of the aerosol-forming base material in Production Example 1.

### Example 4

An electronic cigarette cartridge was prepared in the same manner as in Example 1 except that the aerosol-forming base material prepared in Production Example 5 was used instead of the aerosol-forming base material in Production Example 1.

### Example 5

An electronic cigarette cartridge was prepared in the same manner as in Example 1 except that the aerosol-forming base material prepared in Production Example 6 was used instead of the aerosol-forming base material in Production Example 1.

### Example 6

An electronic cigarette cartridge was prepared in the same manner as in Example 1 except that the aerosol-forming base material prepared in Production Example 8 was used instead of the aerosol-forming base material in Production Example 1.

An electronic cigarette cartridge was prepared in the same manner as in Example 1 except that the aerosol-forming base material prepared in Production Example 9 was used instead of the aerosol-forming base material in Production Example 1.

### Comparative Example 1

An electronic cigarette cartridge was prepared in the same manner as in Example 1 except that the aerosol-forming base material prepared in Production Example 4 was used instead of the aerosol-forming base material in Production Example 1.

### Comparative Example 2

An electronic cigarette cartridge was prepared in the same manner as in Comparative Example 1 except that the aerosol-forming base material prepared in Production Example 7 was used instead of the aerosol-forming base material in Production Example 1.

With respect to the above obtained electronic cigarette cartridges, the following evaluations were conducted.

### Evaluation 1:

20 prepared electronic cigarette cartridges were filled in a paper box of 70 mm×14 mm×45 mm in height so that the aerosol-forming base material faced the bottom. The box containing the electronic cigarette cartridges was put in a polyethylene bag and left to stand in a 5° C. environment for 48 hours.

Then, the electronic cigarette cartridges were taken out, left to stand at room temperature under ordinary pressure for 1 day and subjected to the following evaluation. The surface of the aerosol-forming base material of the electronic cigarette cartridge was observed from one end side, and the number of white crystals of menthol on each cartridge was counted visually with a magnifier of 5 magnifications.

A: No white crystal observed.

B: 1 to 4 white crystals observed.

C: 5 or more white crystals observed.

The electronic cigarette cartridge with the evaluation result C has a high possibility that menthol will be lost and its cooling sensation will be impaired e.g. by long-term storage.

### Evaluation 2:

The electronic cigarette main body used is described. The electronic cigarette main body used was IQOS (registered trademark) which is a heated electronic cigarette made of Philip Morris. The scheme of the electronic cigarette is as follows. The heating element (211) has a width of 4.5 mm, a length to the tip of 12 mm and a thickness of 0.4 mm. The inner diameter of the inserting portion (210) is 7 mm, which is substantially equal to the outer diameter of the electronic cigarette cartridge. The heating element (211) generates heat by an electric power supplied from a battery (not shown in the diagram) provided inside the electronic cigarette main body (200) and reaches about 370° C. By an internal control system, use of one electronic cigarette cartridge is completed by 14 puffs. When the electronic cigarette cartridge in Examples is inserted, the electronic cigarette cartridge portion which appears on the outside from the downstream side of the electronic cigarette main body is about 20 mm.

The electronic cigarette cartridge prepared in each of Examples of the present invention and Comparative Examples was inserted into the electronic cigarette main body to conduct cigarette flavor test.

In the cigarette flavor test, the prepared electronic cigarette cartridges were filled in a paper box of 70 mm×14 mm×45 mm in height so that the aerosol-forming base material faced the bottom. Using a sample having the electronic cigarette cartridge left to stand in a 25° C. environment for 2 weeks and a sample immediately after preparation, a sensing test regarding menthol flavor was conducted. The sensing test was conducted on the flavor of menthol of the sample immediately after preparation and the sample after left to sand. The sensing test was performed by five smokers.

The evaluation standards are as follows.

A: Menthol flavor of the sample after left to stand does not change as compared with the sample immediately after preparation.

B: Menthol flavor of the sample after left to stand is slightly weak as compared with the sample immediately after preparation.

C: Menthol flavor of the sample after left to stand is distinctively weak as compared with the sample immediately after preparation.

The test results are shown in Table 2.

TABLE 2

| | Filler used | Evaluation 1 | Evaluation 2 |
|---|---|---|---|
| Ex. 1 | Production Ex. 1 | A | A: 5 |
| Ex. 2 | Production Ex. 2 | A | A: 5 |
| Ex. 3 | Production Ex. 3 | A | A: 5 |
| Ex. 4 | Production Ex. 5 | B | A: 5 |
| Ex. 5 | Production Ex. 6 | B | A: 3 B: 2 |
| Ex. 6 | Production Ex. 8 | A | A: 5 |
| Ex. 7 | Production Ex. 9 | A | A: 5 |
| Comp. Ex. 1 | Production Ex. 4 | C | B: 5 |
| Comp. Ex. 2 | Production Ex. 7 | C | B: 4 C: 1 |

According to the above-described embodiments of the present invention, the following effects are obtained.

According to the present invention, it is possible to produce a non-tobacco plant composition to be used for an electronic cigarette using a non-tobacco plant with which not only an aroma and flavor of the plant containing no tobacco component but also cooling sensation of menthol can be enjoyed, capable of keeping menthol flavor even after long-term storage.

According to the present invention, it is possible to produce a non-tobacco plant composition capable of keeping menthol flavor even after long-term storage, easily at a low cost.

According to the present invention, it is possible to provide an electronic cigarette filler using a non-tobacco plant having favorable long-term storage stability, and to provide an electronic cigarette cartridge using a non-tobacco plant having favorable long-term storage stability.

The present invention has been described with reference to the specific embodiments, however, the present invention is by no means restricted to such embodiments. Various changes and modifications are possible without departing from the intension and the scope of the present invention.

### REFERENCE SYMBOLS

10: upstream side (one end side)
20: downstream side (the other end side)
100: electronic cigarette cartridge
110: aerosol-forming base material
111: filler
130: transferring member
140: mouthpiece
150: packaging member
151: wrapping member
170: cover
180: partitioning member
200: electronic cigarette main body
210: inserting portion
211: heating element
300: support element
201: electronic cigarette main body
410: exterior portion
420: control portion
430: movable cover
431: air hole
440 heating portion
450: inserting portion
101: electronic cigarette cartridge
530: hollow tubular member

1. An electronic cigarette filler containing a non-tobacco plant, an aerosol former and menthol,
wherein the menthol reduction rate d, defined as d={(d(24)−d(48)}/d(0), is at most 0.60, where d(0) is the content of menthol in the electronic cigarette filler, d(24) is the mass of the electronic cigarette filler after left at stand at 5° C. for 24 hours, and d(48) is the mass of the electronic cigarette filler after left at stand at 5° C. for 48 hours.

2. The electronic cigarette filler according to claim 1, which has a menthol content of at least 0.1 mass % and at most 10 mass %.

3. The electronic cigarette filler according to claim 1, which contains a water-insoluble crosslinked polymer.

4. The electronic cigarette filler according to claim 3, wherein the content of the water-insoluble crosslinked polymer is at least 0.1 time and at most 20 times the menthol content.

5. The electronic cigarette filler according to claim 3, which has a content of the water-insoluble crosslinked polymer of at least 2 mass % and at most 20 mass %.

6. The electronic cigarette filler according to claim 3, wherein the water-insoluble crosslinked polymer is polyvinyl polypyrrolidone.

7. An electronic cigarette cartridge to be used for an electronic cigarette main body which generates an aerosol by heating an aerosol-forming base material, comprising an aerosol-forming base material and a mouthpiece from one end to the other end, and wherein the aerosol-forming base material contains the electronic cigarette filler as defined in claim 1.

8. A process for producing a non-tobacco plant composition, comprising a menthol-dissolving step of preliminarily mixing menthol, a lower alcohol and a water-insoluble crosslinked polymer to obtain a menthol-dissolved product, and a mixing step of mixing a non-tobacco plant, an aerosol former and the menthol-dissolved product obtained by the menthol-dissolving step.

9. The process for producing a non-tobacco plant composition according to claim 8, wherein the amount of the water-insoluble crosslinked polymer added is at least 10 parts by mass and at most 2,000 parts by mass per 100 parts by mass of menthol.

10. The process for producing a non-tobacco plant composition according to claim 8, wherein in the menthol-dissolving step, menthol is dissolved in the lower alcohol and then the water-insoluble crosslinked polymer is added and mixed.

11. The process for producing a non-tobacco plant composition according to claim 8, wherein the lower alcohol is ethyl alcohol.

12. The process for producing a non-tobacco plant composition according to claim 8, wherein the water-insoluble crosslinked polymer is polyvinyl polypyrrolidone.

13. A process for producing an electronic cigarette filler, which comprises a filler-forming step of forming the non-tobacco plant composition obtained by the production process as defined in claim 8 into an electronic cigarette filler.
